(19) United States
(12) Patent Application Publication
(10) Pub. No.: US 2022/0335220 A1
(43) Pub. Date: Oct. 20, 2022

(54) ALGORITHMIC TOPIC CLUSTERING OF DATA FOR REAL-TIME PREDICTION AND LOOK-ALIKE MODELING

(71) Applicants: Pavan Korada, San Rafael, CA (US); Savitha Namuduri, Frisco, TX (US); RC Rizzo, New York, NY (US); Jolene Liu, Long Island, NY (US)

(72) Inventors: Pavan Korada, San Rafael, CA (US); Savitha Namuduri, Frisco, TX (US); RC Rizzo, New York, NY (US); Jolene Liu, Long Island, NY (US)

(21) Appl. No.: 17/724,066

(22) Filed: Apr. 19, 2022

Related U.S. Application Data
(60) Provisional application No. 63/176,462, filed on Apr. 19, 2021.

(51) Int. Cl. G06F 40/30; G06N 5/02; G06F 3/0484; H04L 67/50

(52) U.S. Cl. CPC G06F 40/30; G06N 5/022; G06F 3/0484; H04L 67/535

(57) ABSTRACT

The subject technology provides a user classification system comprising a communications network, a Front-End URL Handler (FEUH) establishing an entry point for content calls from a network user, and a Fast Retrieval (FR) store storing a set of behavioral segments. A classification engine performs operations comprising accessing a plurality of pages viewed by a communications network user, classifying the plurality of pages as pertaining to at least one topic of a plurality of topics, tracking a count of each of the pages viewed by the communications network user for each of the topics, tracking a recency or frequency with which each of the pages viewed by the communications network user was viewed for each of the topics, characterizing the communications network user as belonging to one or more of the behavioral segments based on the tracked count and tracked recency, and serving content to the communications network user based on a targeting parameter and the behavioral segment characterization.

### CLAIM OF PRIORITY

This patent application claims the benefit of priority, under 35 U.S.C. Section 919(e), to Korada et al, U.S. Provisional Patent Application Ser. No. 63/176,462, entitled “METHOD AND SYSTEMS OF ALGORITHMIC TOPIC CLUSTERING FOR REAL-TIME INTENDER PREDICTION AND LOOK-ALIKE MODELING,” filed on Apr. 19, 2021 (Attorney Docket No. 4525.167PRV), which is hereby incorporated by reference herein in its entirety.

### TECHNICAL FIELD

The subject matter disclosed herein generally relates to the technical field of systems and methods for algorithmic topic clustering of data for real-time prediction and look-alike modeling. Some examples relate to computer-enhanced cross-topic classification and data management.

### BACKGROUND

The present subject matter seeks to address technical problems existing in topic clustering and classification of research and/or other production data. In some instances, data is not recorded or classified properly. This may occur for example in research or machine learning programs when the data is not classified in accordance with accepted standards of the particular academic field. Should another researcher or programmer wish to replicate the research or learning, improper recording of the original data would make any attempt to replicate the work questionable at best. Also, should an allegation of misconduct arise concerning the results, having the data improperly recorded will greatly increase the likelihood that a finding of misconduct will be substantiated.

Another challenge can arise when data is not maintained properly, for example the information is not maintained in sufficient detail, is inaccurately classified, or not maintained in identifiable files. In other areas, with the great volume of data content placed on the internet in modern times (much of it potentially misleading or biased), cross-topic classification and the drawing of meaningful inferences and identifying reliable trends has become increasingly difficult. Increasingly, content providers try to reach target audiences, interested parties, allies and the like with increasing accuracy and breadth. Very often, this task becomes impossible for humans to track or perform, and even conventional technology struggles to keep up abreast in discerning what is true or fake content, for example.

In this regard, characterizing the behavior of users of the Internet is difficult to accomplish. Known methods may involve for example combining information about the user that is self-reported along with purchase behavior, click behavior, and general information about the domain of the websites visited by the users. While this information can provide insights, it is limited.

### BRIEF DESCRIPTION OF THE DRAWINGS

Some embodiments are illustrated by way of example and not limitation in the figures of the accompanying drawings.

FIGS. 1-8 depict aspects of some examples of the present disclosure.

FIG. 9 is a block diagram illustrating a high-level network architecture, according to an example embodiment.

FIG. 10 is a block diagram showing architectural aspects of a classification engine, according to some example embodiments.

FIG. 11 is a block diagram illustrating a representative software architecture, which may be used in conjunction with various hardware architectures herein described.

FIG. 12 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiment of the inventive subject matter. It will be evident, however, to those skilled in the art that embodiments of the inventive subject matter can be practiced without these specific details. In general, well-known instruction instances, protocols, structures, and techniques have not been shown in detail. It should be understood by those with skill in the art may combine elements from various embodiments in practicing the present subject matter.

The present disclosure is directed in some examples to systems, methods, and computer-readable storage media for algorithmic topic clustering of data for real-time prediction and look-alike modeling. Some examples include seeking to characterize behavior of users of a communications network, such as the Internet. A plurality of pages viewed by a communications network user are classified as pertaining to one of a plurality of topics. A count of each of the pages viewed by the communications network user for each of the topics is tracked, as is a recency with which each of the pages viewed by the communications network user was viewed for each of the topics. The communications network user is characterized as belonging to one or more behavioral segments based on the count and the recency. Targeted content such as advertisements are served to the communications network user based on at least advertising targeting parameters and the characterization. In some examples, the disclosure is further directed to contextual combination of topics in part by coincidence of topic visits across multiple people.

In some examples, topics are algorithmically categorized into intender and nonintender groups using natural language processing. In this regard, an intender group may be operationally defined as a group of subjects having a purchase probability above a certain threshold, for example greater than 0.50 (i.e., more than 50% probability). A nonintender group may be operationally defined as a group of people whose purchase probabilities were less than a given threshold, for example less than 0.50 (i.e., less than 50% probability). In seeking to differentiate between intenders and nonintenders, the technical challenges can be significant, as discussed more broadly above. The present disclosure seeks to provide improve technology and solutions to address these challenges.

Taking one classification example, for instance, buying plans and attitudes toward durable goods are subjectively extremely variable. Most individual durable goods purchased involved a substantial expenditure, are infrequently purchased by any single household, and provide considerable latitude in the timing of their acquisition. One of the problems associated with an intentions survey is its inefficiency of the basic predictors of purchase rates. As a method of data collection, responses are generally classified into several categories such as “definitely will buy,” “probably,” and “no,” for the expression of buying intentions. The usefulness of the survey is then evaluated by relating variations in the fraction of one or more groups of intenders (respondents reporting “definitely” or “probably”) to variations in the fraction reporting purchases. It is puzzling in most studies that data represent only the intenders; and there is no survey evidence that bears directly on the predictability of the critically important movements in nonintenders' purchase rates. As a consequence, the accuracy of purchase predictions based on intentions surveys depends largely on whether or not changes in proportion of intenders can successfully predict changes in the purchase rate of nonintenders being strongly correlated over time. By and large, the findings derived from a number of conventional approaches are conflicting and thus not very convincing. It appears that these controversies are due to difficulties in data collection methods. For example, in human-based approaches using direct questioning, the relative influence of different family members on purchases obtained by direct questioning of only one of the family members is highly limited. Examples of the present disclosure seek to provide objective means to determine the differences between intenders and nonintenders in estimating purchase probabilities.

In general, “inventory” in this context may be a term for a unit of advertising space, such as a magazine page, television airtime, direct mail message, email messages, text messages, telephone calls, etc. Advertising inventory may be advertisements a publisher has available to sell to an advertiser. In certain embodiments, advertising inventory may refer to a number of email advertisements being bought and/or sold. The terms “inventory” and “advertising inventory” may be used interchangeably. For email marketing campaigns, advertising inventory is typically an email message.

A “publisher” in this context may be an entity that sells advertising inventory, such as those produced by the systems and methods herein, to their email subscriber database. An advertiser may be a buyer of publisher email inventory. Examples of advertisers may include various retailers. A marketplace may allow advertisers and publishers to buy and sell advertising inventory. Marketplaces, also called exchanges or networks, may be used to sell display, video, and mobile inventory. In certain embodiments, a marketplace may be an email exchange/email marketplace. An email exchange may be a type of marketplace that facilitates buying and/or selling of inventory between advertisers and publishers. This inventory may be characterized based on customer attributes used in marketing campaigns. Therefore, an email exchange may have inventory that can be queried by each advertiser. This may increase efficiency of advertisers when purchasing inventory. A private network may be a marketplace that has more control and requirements for participation by both advertisers and publishers.

An “individual record” or “prospect” in this context may be at least one identifier of a target. In certain embodiments, the individual record/prospect may be identified by a record identification mechanism, such as a specific email address (individual or household) that receives an email message.

An “audience” in this context may be a group of records, which may be purchased as inventory. In certain embodiments, an audience may be a group of records selected from publisher databases of available records such as a group of consumers and their affiliated profiles. The subset of selected records may adhere to a predetermined set of criteria, such as common age range, common shopping habits, and/or similar lifestyle situation (i.e., stay-at-home mother). Advertisers generally select the predetermined set of criteria when they are making an inventory purchase.

A “carrier signal” in this context in this context refers to any intangible medium that is capable of storing, encoding, or carrying instructions for execution by a machine, and includes digital or analog communications signals or other intangible media to facilitate communication of such instructions. Instructions may be transmitted or received over a network using a transmission medium via a network interface device and using any one of a number of well-known transfer protocols.

A “client device” in this context refers to any machine that interfaces with a communications network to obtain resources from one or more server systems or other client devices. A client device may be, but is not limited to, a mobile phone, desktop computer, laptop, portable digital assistant (PDA), smart phone, tablet, ultra-book, netbook, laptop, multi-processor system, microprocessor-based or programmable consumer electronics system, game console, set-top box, or any other communication device that a user may use to access a network.

A “communications network” or “network” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling of the client device to the network may be a Code Division Multiple Access (CDMA) connection, a Global System for Mobile communications (GSM) connection, or another type of cellular or wireless coupling. In this example, the coupling may implement any of a variety of types of data transfer technology, such as Single Carrier Radio Transmission Technology (1×TT), Evolution-Data Optimized (EVDO) technology, General Packet Radio Service (GPRS) technology, Enhanced Data rales for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

A “component” in this context refers to a device, a physical entity, or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

An “engine” is a system that includes a component or a group of components that operate to perform one or more of the operations or methods described herein.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein, A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors,

It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, in instances where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

A “machine-readable medium” in this context refers to a component, a device, or other tangible media able to store instructions and data temporarily or permanently, and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

A “processor” in this context refers to any circuit virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), or any combination thereof. A processor may further be a multi-core processor having two or more independent processors (sometimes referred to as “cores”) that may execute instructions contemporaneously.

Reference will now be made in detail to the embodiments of the present inventive subject matter, examples of which are illustrated in the accompanying drawings. Wherever possible, like reference numbers will be used for elements.

Some methods and systems described herein characterize Internet users based on the context of the pages they visit. This is sought to be accomplished through the use of contextual information derived from a classification engine and an application of parameters in defining that classification. In some examples, the disclosed technology uses a real-time classification engine, classifying individual pages visited by a user.

Behavioral characterization of a user is based on the concept of determining the actions of that user over time. In connection with the present disclosure, that concept is adapted to utilize a classification system to determine what, contextually, a person is looking at on the Internet, over time, in order to characterize the person, for example in an intender or nonintender group. Once the person is characterized, that information can be used in many ways, including determining what types of Internet advertisements should be served to that person.

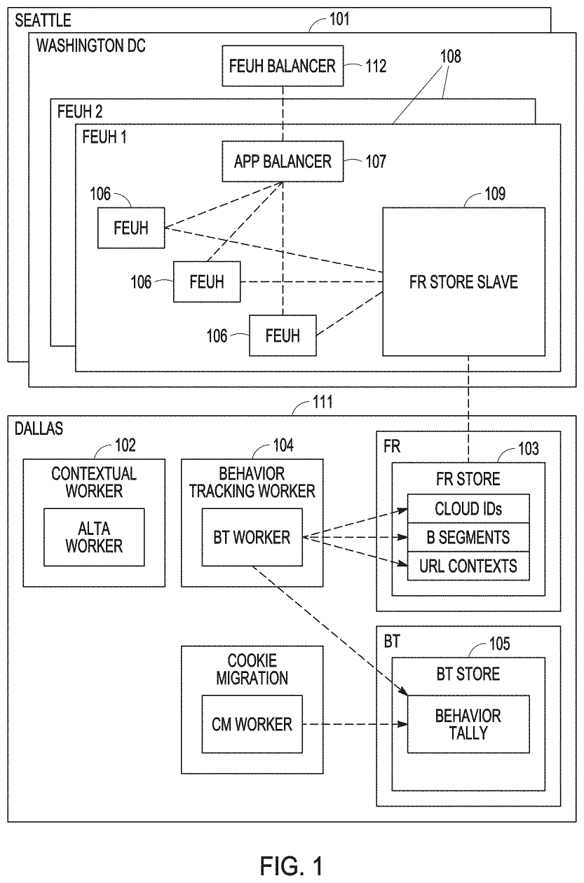

The following disclosure describes an exemplary system (referring to FIG. 1) used in conjunction with a classification engine to characterize and behaviorally target advertisements to Internet users.

A computer system for implementing examples of the present disclosure includes one or more processors and computer-readable storage (e.g., memory devices or other computer-readable storage media) storing programs (e.g., computer-executable instructions) for execution by the one or more processors. Computer-readable storage media may include volatile and non-volatile, removable and non-removable media implemented in any method or technology for storage of information such as computer-readable instructions, data structures, program modules, or other data. Computer-readable storage media may include, but is not limited to, RAM, ROM. Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information, and which can be accessed by the computer system.

Such a system may include the following components, with reference to FIG. 1, in one embodiment: a classification engine 102; a software program, within classification engine 102, that tallies each classification per user; a behavioral tracking engine 104 that takes those tallies and derives behavioral characterizations referred to herein as behavioral segments, which are stored in a storage medium (referred to herein as Fast Retrieval (FR) store 103); a storage medium 105 (referred to herein as behavioral tracking store 105) to persist the behavioral segments; and a retrieval mechanism for utilizing those descriptions in connection with serving advertisements to users over the Internet.

Referring still to FIG. 1, a Front-End URL Handler (FEUH) 101 is the entry point for ad calls. It translates into Javascript a URL passed from a publisher that calls an ad server. FIG. 1 does not depict an ad server, as it sits outside of the domain of the exemplary system illustrated. In the illustrated system, the FEUH 101 serves an ad tag to the user's browser, which then calls an ad server (not shown) for serving the ad to the user's browser.

The FEUH 101 is communicatively coupled to a communications network that may comprise multiple data centers (in the example shown in FIG. 1, located in Dallas, Tex., Seattle, Wash., and Washington, D.C., for purposes of illustration). Each network cluster comprises one or more load balancers 112 and one or more FEUH server farms 108, in the illustrated exemplary embodiment. Each FEUH server farm 108 has its own local HTTP balancer 107, multiple FEUH applications 106, and is associated with read-only Fast Retrieval (FR) store 109, again, in the illustrated exemplary embodiment.

Embedded in the FEUH application 106 is business logic for handling a specific set of parameters passed to it. By way of example, the FEUH application 106 reads the page URL parameter; checks the domain or URL against a list of approved sites (i.e., the approved site list validates the source of the ad call and prevents running ads and processing on unapproved sites); passes the URL to classification engine 102; examines the site and zone parameters (i.e., the site parameter is the identification of the publisher/site that is recognized by the ad server and the zone parameter is a subsection of the site as defined by the publisher, which may be used for ad targeting and trafficking purposes); checks for any exceptions related to those sites or zones (for example, specific classifications used for any site or zone); checks the network identifier parameter (i.e., an alphanumeric code that uniquely identifies the ad network running the tag); performs any special processing for that network; and retrieves the context for the page URL.

The Fast Retrieval (FR) store 103 comprises and processes a set of behavioral segments and is attached to a CloudID, Network, Mapping and Context and a set of contexts attached to a URL (e.g., the site and zone parameters, site and zone exceptions, network identifier parameters, and the like). The FEUH application 106 makes use of these pieces of data to craft the necessary ad call to an ad server. For example, the ad call would include a series of parameters, formatted as key/value pairs in a query string, that would influence the ad server's decision on which ad to serve. Multiple key/value pairs may be used if the particular user matches multiple behavioral segments.

A cloud store 111 adds intelligence to the business logic in the FEUH application 106. The cloud store 111 includes a set of data stores and workers or processors that operate in concert to form the data for the FR store 103 so that the FEUH application 106 can make decisions and deliver the proper parameters to an ad server. For example, the business logic used in this respect determines what behavioral characteristics to apply to different segments and determines matching characteristics for the current user (e.g., if user history indicates more than 15 impressions on sports pages in the last 5 days, that user may match the sports-fan segment name.)

A behavioral tracking store 105 includes a B-tree-based disk database, in the exemplary embodiment, that utilizes an HTTP interface with memory-based caching. Every time a cloud user is seen on the network, the visit is recorded to a given site based on the user's ID, network, mapping and context. This results in a dataset that is multiple times larger than the size of the total unique users because of the segmentation of the data needed.

The fast retrieval store 103 includes a key-value memory-based datastore that utilizes a network communication protocol. Fast retrieval store 103 comprises the end result of the other workers and stores used in connection with the system. It is the final data that is replicated out to all of the FEUH 101 to help in the delivery of ads. Such data would take the form, in an exemplary embodiment, as follows: COMPANYID_NETWORK_MAPPING=[“SEGMENT1”, “SEGMENT2”]. Thus, the key is a concatenation of (a) the unique user ID, (b) the network company identifier, and (c) the contextual mapping identifier. SEGMENT1, SEGMENT 2 etc. are the names of the segments whose definitions match the user's behavior pattern. For example, 12345_cm_default=[“cm.sports_L”, “cm.polit_H”] signifies user 12345 for the default context mapping on network; and cm matches the cm network sports-light and politics-heavy segments. This data organization supports any number of external data providers.

The following disclosure describes example operations that are involved in one embodiment of the behavioral targeting process. A user interface is provided that allows a company to set up behavioral segments by creating a classification mapping and setting behavioral parameters around that classification mapping as described herein. These parameters include the probability percentage that a page is about a certain classification or topic cluster code, the frequency with which that type of classification is visited, and the recency or time interval involved, as described above.

Once the parameters are established, behavioral characterization is used in connection with the process of classification of Internet pages. As advertisements are served to a user viewing Internet pages and classification of the pages visited is accomplished, a cookie is dropped to uniquely identify the user.

A record corresponding to the cookie is created in the storage mechanism (e.g., cloud store 111) and a classification for that page is registered in the behavioral tallying cache. A process regularly reviews the behavioral tallying cache using the parameters set up by the company and as described herein to identify users that qualify for various behavioral segments.

The cloud store 111 is then updated with the behavioral segments, and cache expirations are set as to maintain the validity of the behavioral segments. This is done in some examples to separate out users that are “in market” for various behaviors versus “out of market”. For example, consider a user that is looking for a new mortgage. In general, people typically do not look for a mortgage for over 30 days. The cached expiration helps contain the problem of infinite growth for those people who clear their cookies.

As advertisements are served, they are processed by the FEUH 101 which performs a lookup in the cloud store 111 to determine to what behavioral segments a user belongs. This is accomplished by checking the cookie of the user for his unique ID. If the cookie does not exist, a new cookie is created with a new ID.

The behavioral segments passed along to the ad server are passed by dynamically creating an ad call based on the ad server being targeted. The ad server then reads the ad call and identifies the various targeting parameters, including the behavioral segments, and serves an ad accordingly.

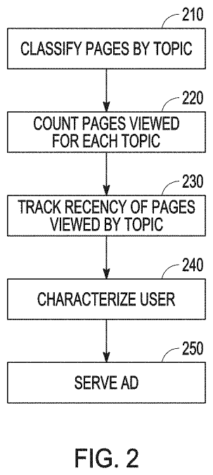

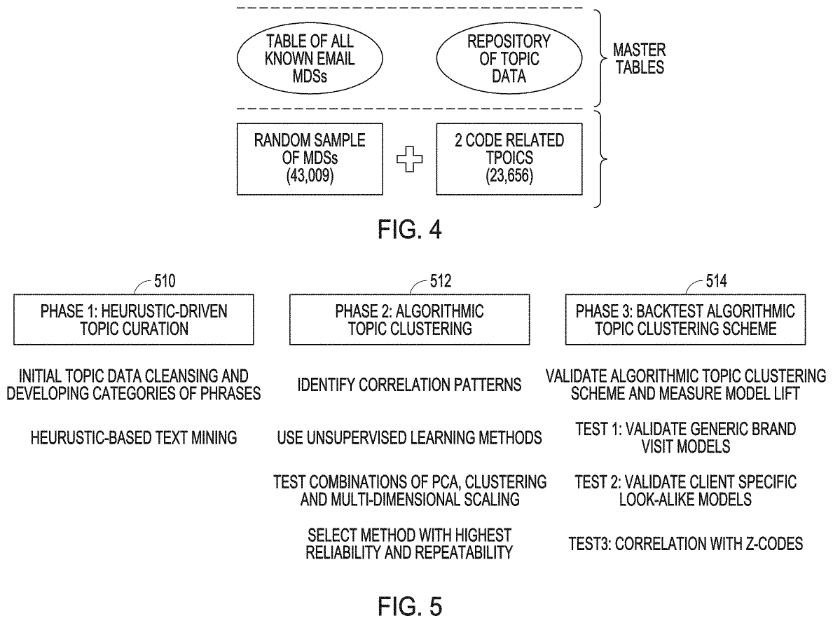

With reference to FIG. 2, a flow diagram of an exemplary method of the present disclosure is illustrated. In step 210, a plurality of pages viewed by a communications network user are classified as pertaining to one of a plurality of topics. The plurality of pages may include a sample of web pages accessible via the Internet or other communications network. For example, the sample of web pages may include 100,000 or more unique documents published at different domains. To classify the web pages, each web page may be tagged manually or programmatically (e.g., using an HTML parser to extract keywords, common terms, and or important terms based on a programmatic analysis of the document context using natural language processing (NLP) or other machine learning techniques. The tags may be specific to each web page and may include keywords or other text extracted from the web page document. Multiple tags for each webpage may be generated so that 1,000,000 or more tags may be generated for the sample of web pages. The tags may then be clustered into topics using one or more of the algorithmic techniques described below in FIGS. 4-5. Each web page in the plurality of pages is then classified based on the topic codes associated with the page.

In step 220 a count of each of the pages viewed by the communications network user is tracked. The topic codes associated with pages viewed are then aggregated to determine the topics that are most frequently browsed by the user. In step 230, a recency with which each of the pages viewed by the communications network user is also tracked. In various embodiments, a recency for each of the topic classifications associated with the viewed pages may also be determined. In step 240, the communications network user is characterized as belonging to one or more behavioral segments based on the number and the recency of the pages viewed and the topics codes associated with the each of the viewed pages. Advertisements are served to the communications network user based on at least advertising targeting parameters and the characterization in step 250.

In some method examples, an example method, at a classification system, of classifying a communications network user comprises: accessing a plurality of pages viewed by the communications network user; classifying the plurality of pages as pertaining to at least one topic of a plurality of topics; tracking a count of each of the pages viewed by the communications network user for each of the topics; tracking a recency or frequency with which each of the pages viewed by the communications network user was viewed for each of the topics; characterizing the communications network user as belonging to one or more of the behavioral segments based on the tracked count and tracked recency; and serving content to the communications network user based on a targeting parameter and the behavioral segment characterization.

In some examples, the method further comprises providing a third-party user interface allowing a third-party to define at least one of the behavioral segments; and receiving a third-party definition of at least one behavioral segment.

In some examples, receiving the at least one behavioral segment includes receiving a classification mapping, and wherein the method further comprising setting behavioral parameters associated with the classification mapping.

In some examples, at least one of the behavioral parameters includes a probability percentage that a page among the plurality of pages viewed by a communications network user relates to the at least one topic of the plurality of topics.

In some examples, at least one of the behavioral parameters includes a probability percentage relating to a frequency with which the page or the at least one topic is seen by the network user.

In some examples, at least one of the behavioral parameters includes a probability percentage relating to a recency with which the page or the at least one topic is seen by the network user.

In some examples, a non-transitory machine-readable medium includes instructions which, when read by a machine, cause the machine to perform operations in a method of classifying a communications network user, the operations comprising any one or more of the operations summarized above, or described elsewhere herein.

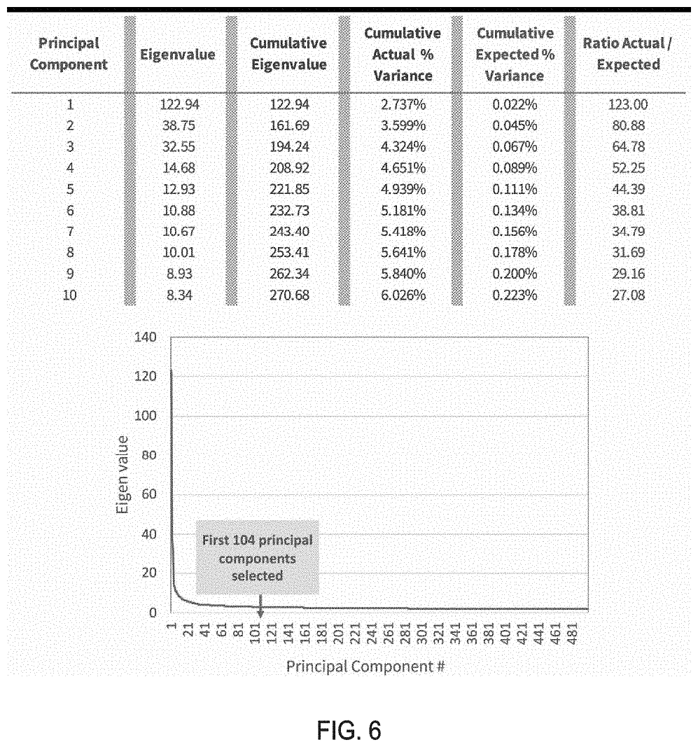

Some examples described herein thus serve to discover topic categories that can simplify the linkage between the browsing behavior of a communications network user and behavioral segments. As explained below in FIGS. 6-8, interpreting behavioral segments (e.g., an intent to buy product X) from a granular model for browsing behavior (e.g., a model that includes millions of tags or more for a sample of web pages) is extremely difficult. Using a less granular model for browsing behavior contextualizes the content of each web page into topics which may be used to interpret behavioral segments with more specificity and accuracy despite the information loss incurred by using the less granular model. The commonality between the algorithmically clustered topics and behavioral segments is proven by the increased brand visit probabilities, more accurate look alike models, and strong correlation with gold standard manually curated topics shown in the validation tests described below. Using the algorithmically clustered topic codes for page classification also improves computational efficiency and reduces computational load, cost, and complexity relative to more granular approaches for page classification and browsing behavior modeling.

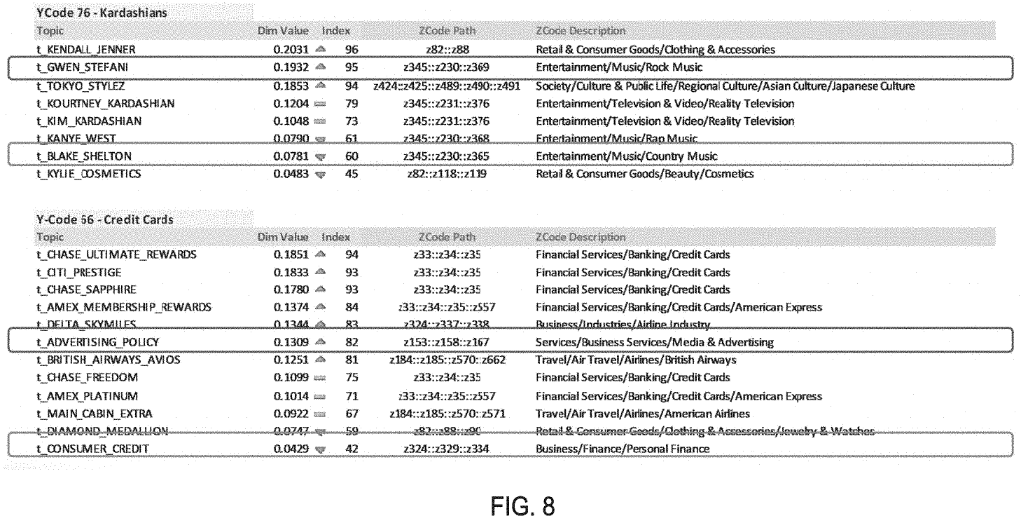

The algorithmic clustering techniques can also discover topic categories that can or should be grouped together outside of what a human would expect or predict. As an illustrative example, the classification engine may group together a topic on “tokyo hairstyle” as part of a category that also contains “Kardashians” to discover that one of the family members of the Kardashians is wearing Tokyo-inspired hairstyles. A traditional category classification system may group “tokyo hairstyle” with “hairstyles” or “Japanese culture” and miss the cross-connected topic of “tokyo hairstyle” interests with those who are interested in the Kardashians. Other examples, of topic categories outside of what a human could identify that were discovered algorithmically are shown below in FIG. 8. As shown in the validation tests, the cross-topic discovery is beneficial in generating look-alike audiences.

As mentioned above, in some examples, behavioral characterization of a user is based on the concept of determining the actions of that user over time. In connection with the present disclosure, that concept is adapted to utilize a classification system to determine what, contextually, a person is looking at on the Internet, over time, in order to characterize the person, for example in an intender or nonintender group. Once the person is characterized, that information can be used in many ways, including determining what types of Internet advertisements should be served to that person.

In some examples, the characterizations are dictated through a set of parameters. These parameters include, in one embodiment, a probability percentage that a page is about a certain topic (i.e., classification), a frequency or number with which that classification is seen, and a recency with which it has occurred.

For example, in order to characterize a user as one who was interested in sports, the parameters setup would be to identify users that visit pages that are X % probability or more about sports, visited or viewed Y or more times, within a Z period of time or recency. By way of a specific example, a user that visits pages 50% or more likely to be about sports, ten (10) or more times, within the last week would be an exemplary behavioral characterization using a baseline classification system. In order to classify pages, different methodologies can be used. One such method of classifying Internet pages is described in U.S. Pat. Nos. 8,762,382 and 9,262,509, owned by the assignee of the present application, which are hereby incorporated by reference in their entirety.

In another example, a classification engine, in this case a website classification engine, algorithmically parses website, URLs, and metadata into topic categories. This process creates topics and uses natural language processing to heuristically categorize the webpages into these hierarchical topics.

In some examples, an algorithmic topic generation can be used with or separate from existing non-algorithmic topic generation. In some embodiments, the topics generated and/or categorized by the natural language processor correspond to an existing audience topic classification hierarchy. In some embodiments, the two classification systems co-exist to provide tandem classifications for further behavioral classification enrichment. In some examples, only algorithmic topic classification/generation is used.

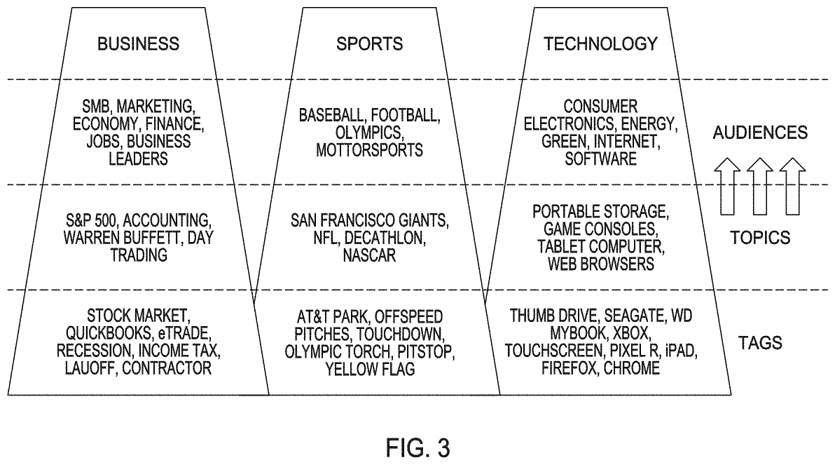

In some examples, intender and nonintender group classification topics are generated using tags. As described above, the tags may be specific for each web page included in a sample. The tags may be generated manually and or programmatically (e.g., by extracting common and or important terms from the document text of each web page). Some example tags are shown in FIG. 3. The tags are then classified into topic codes and the topic codes may be associated with one or more audience segment groups. Illustrative examples are shown in FIG. 3. In this example, a website visit to pages that are tagged as relating to “stock market,” “Quickbooks,” “eTrade,” “recession,” “income tax,” “layoff,” and “contractor” are classified into the “S&P 500”, “accounting”, “Warren Buffett”, and “day trading” topic codes. These topics codes may be associated with the “SMB”, “marketing”, “economy”, “finance”, “jobs”, and “business leaders” audience segments.

With reference to FIG. 4, in some examples a classification engine algorithmically clusters existing more granular topic sets to generate a smaller set of topic codes that have more commonality with and are more predictive of a behavioral segment. (e.g., have a higher accuracy in a prediction or a probability of a brand visit, purchase intent, and the like). The classification engine begins with inputs that may be used in non-algorithmic classification and, using underlying tags, combines for example (by order of magnitude) thousands of topics into hundreds of more predictive topics. In some examples, the classification engine performs heuristic topic curation. The initial topic data is cleansed and developed into categories and phrases. Heuristics may be based on text mining. In some examples, the classification engine then performs algorithmic topic clustering. In some examples, the algorithmic topic clustering is then back tested to validate the topic clustering scheme to measure a model lift.

With reference to FIG. 5, in some examples, in a first phase 510, topics are normalized. Normalization may include stemming, lemmatization, or any other like form of normalization. That is, the classification engine may normalize “Economics” “Economic” and “Economic Indicators” to all be retained as “Economics.”

In some examples, a second phase 512 includes algorithmic topic clustering. After the topics have been normalized, the classification engine algorithmically clusters the topics. One or more algorithmic topic clustering methods may be used. In some examples, the clustering is done by a combination of unsupervised learning algorithms including principal learning algorithms, disjoint clustering, and multidimensional scaling. In some examples, the topic clustering may use any combination of principal learning algorithms, other supervised or unsupervised clustering algorithms.

With reference to FIGS. 6-8, some examples identify correlation patterns, and then use unsupervised learning methods and test combinations of Principal Component Analysis (PCA), clustering, and multi-dimensional scaling. PCA is a statistical procedure to convert a set of observations of possibly correlated variables into a set of values of linearly uncorrelated variables. To cluster the set of web page tags using PCA, each tag may be mapped to a feature space in order to generate a numeric representation of the tags. New variables (e.g., the topic codes) are then be generated based on linear combinations of the tag features. For example, a dispersion (covariance) matrix may be generated for the tag features and the orthonormal eigenvalues and eigenvectors of the dispersion matrix may be identified and used to construct principal components. Each of the principal components is chosen in such a way so that it would describe most of them still available variance; all the principal components are orthogonal to each other. Some examples select a method with a highest reliability and repeatability.

The principal component analysis reduces dimensionality of the topics and can, in some examples, be considered an ellipsoid in a subspace of an initial feature space, and the new basis set in this subspace is aligned with the ellipsoid axes. The principal component analysis may remove highly correlated topics as basis set vectors are orthogonal. The resulting ellipsoid dimensionality matches the initial space dimensionality and allows the classification engine to cut off excessive space. In some examples, this cut off may be done by optimizing the selection of principal components to maximize a sample variance using a greedy algorithm or other greedy strategy. The greedy algorithm may randomly select a number of the principal components and compare the sample variance determined using selected components with the sample variance determined using the excluded components. One or more of the principal components in the selected list may be exchanged with one or more of the principal components in the excluded list. The sample variance for each list may be determined and compared until an optimal configuration of selected principal components is determined (e.g., the selection of principal components having the maximum variance is identified). In some examples, a greedy strategy includes making a decision at a given point without taking account its consequence at future operations. A best local move is determined at each step to reach a goal. The greedy strategy assumes that a group of local best decisions can lead to global optimization.

In some examples, PCA and other clustering techniques may reduce the dimensionality of a dataset including the web page tags by projecting the tags on a set of topic codes that summarize the content of the granular web page tags. PCA and the other clustering techniques described herein aggregate the more granular tags into a smaller, more predictive set of topic codes that have more commonality with the behavioral segments. By summarizing the content of multiple tags, the more predictive topic codes put the content of each web page document included in a sample into a wider context that has more commonality with the behavioral segments required to effectively target audiences.

In examples, browsing sessions are recorded in a data cloud identified for each consumer's identity graph. Each visit will include the website URL, metadata, topics, and tags. In some examples, the classification engine may detect patterns within an individual's and across collective consumers' browsing by determining the co-occurring frequency using learning models.

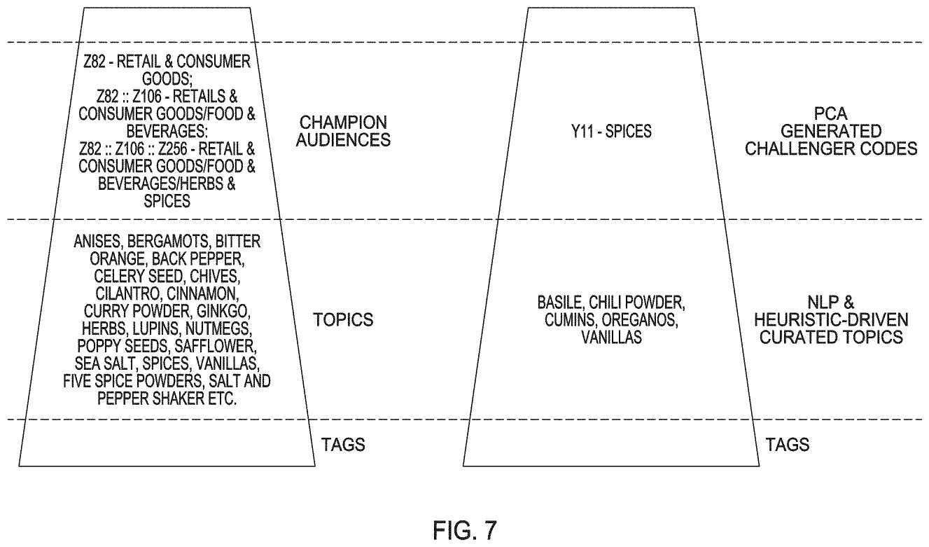

The topics are grouped together and coded. In some embodiments, humans evaluate the topics in each grouping to determine an appropriate group category name. For example, if the classification engine groups together basil, chili pepper, cumin, oregano, and vanilla, an individual monitoring the classification process could code the audience segment as “spices” as shown in FIG. 7 of the attached figures. In some examples, the groupings may be human titled, automatically titled, or remain untitled. In some examples, any method of heuristic grouping may be used to group the topics. In some examples, the classification engine may determine the number of groupings, be predetermined, be static, or change over time via learning.

With reference again to FIG. 5, in some examples, a third phase 514 includes a back-test algorithmic topic clustering scheme. In some examples, the classification engine is back tested against control topic clustering schemes to show improvement and correlation with other metrics. In some examples, a “predictive power” (also known as an “intender clustering” in some examples) is tested against existing topics using a PiQ prediction test on a back-test server. The clustered topics are fitted into a supervised logic regression model with existing categories as a champion and compared to a similar model built by the algorithmic topic clustering as a challenger. The two models predict a probability of a communications network user visiting a brand location based on the topic classifications for the sample of pages viewed by the user. A dependent variable is a binary indicator denoting the presence of a brand visit on a respective PiQ brand. Independent variables for the champion are using the pre-existing topic codes. Independent variables for the challenger are the algorithmically generated cluster codes. The classification engine uses these to determine the incremental lift of the challenger over the champion by determining which has the better Area Under the Curve (AUC) for the selected brand or brands. The larger the AUC the greater the probability that communications network users will visit a brand location. For 17 out of the 24 brands tested, the network users identified as intenders based on the new set of algorithmically clustered topics codes had a greater probability of a store visit compared to the network users identified as intenders based on a legacy set of topic codes. In some examples, the back-test server may test the two models based on audience segment characteristics, demographic clusters, brand categories, or any other metric.

In some examples, the back-test server uses a look-a-like (an LaL) modeling test. The predictive power of the algorithmic topic clustered codes are tested in the back-test server against the non-algorithmic topic clustering in the existing look-alike model for the specified brand. The back-test server fits an existing serviced logic regression model with the existing topic codes as compared to similar model built swapping out the existing topic codes with corresponding algorithmically created topic cluster codes. For the modeling test on the back-test server, the dependent variable is a binary variable in the format of event (1) or non-event (0). Independent variables for the champion CM and HBI look-alike models are the pre-existing topic codes. Independent variables for the challenger CM and HBI look-alike models are the algorithmic topic cluster generated codes. The back-test server determines the AUC for the two models (one based on pre-existing topic codes and the algorithmically generated clustered topic codes for each brand or brands). It should be appreciated that the back-test server may test the two models based on audience segment characteristics, demographic clusters, brand categories, or any other metric.

After determining brands that see the greatest area AUC for predictive selection and/or for look-alike audiences, the back-test server can determine whether the algorithmic topic clustering model is better selected for the given task.

By way of example, available advertising inventory with a given audience segment is available. The back-test server can determine in real time whether the audience segment for the available advertising inventory (i.e., the communications network users that navigate to a domain having available advertising inventory) is better predictive for the given marketer (or which marketer is best for the given audience segment). For example, the back-test server may identify the browsing activity (i.e., the topics of the pages viewed, the count of pages viewed, the recency of the pages viewed, the recency of the topic classifications of the pages viewed, and the like) of the users included in the audience segment by resolving the identity of the users in the audience segment with an identity graph that records browsing activity. The back-test server may classify the users into one or more behavioral segments based on their browsing activity and determine an AUC that represents the probability the user will visit a brand location, click an advertisement, respond to a survey, purchase a product, or achieve another desired outcome associated with one or more marketers. The back-test server may then make bid determines on the available inventory based on the outcome probabilities determined by the back-test server. For example, if the back-test server determines there is a 60% or more probability that the users of the audience segment will visit a Dunkin Donuts location, the back-test server may bid and or increase a bid value for a placement of Dunkin Donuts related advertising or other content at a domain in available inventory that is navigated to by the audience segment. In various embodiments, the back-test server may interface with a bid exchange directly to place and or modify bids. The back-test server may also send the probability predictions to a bidding server that includes logic for placing and or modifying bids on a bidding exchange in response to predictions received from the back-test server.

The back-test server may also determine whether models have the better predictive AUC for the available inventory using pre-existing topic codes or algorithmically generated codes and will use that model to make bid determinations on the available inventory. The back-test server then passes the results of the real-time multi-model prediction to the bidding server.

The back-test server may also determine on a per-brand/marketer/brand category which topic classification, existing or algorithmically generated, is better suited for generating look-alike audience for the target brand/marker/brand category. The back-test server will pass the preferred topic classification for the industry/brand/marketer/brand category so that the look-alike audience generation can generate characteristics like the ideal customer.

In some examples, once a user is behaviorally characterized, that information can be used in a variety of ways, including targeting advertisements to such user based on their behavior as characterized, determining ideal consumer characteristics, determining look-alike audiences based on similar characteristics of ideal consumers, or any other use by markets in the system.

Thus, in some examples user classification system comprises: a communications network; a Front-End URL Handler (FEUH) establishing an entry point for content calls from a network user; a Fast Retrieval (FR) store storing a set of behavioral segments; and a classification engine comprising one or more processors and a memory storing instructions which, when executed by at least one processor in the one or more processors, cause the at least one processor to perform operations comprising: accessing a plurality of pages viewed by a communications network user; classifying the plurality of pages as pertaining to at least one topic of a plurality of topics; tracking a count of each of the pages viewed by the communications network user for each of the topics; tracking a recency or frequency with which each of the pages viewed by the communications network user was viewed for each of the topics; characterizing the communications network user as belonging to one or more of the behavioral segments based on the tracked count and tracked recency; and serving content to the communications network user based on a targeting parameter and the behavioral segment characterization.

In some examples, the operations further comprise providing a third-party user interface allowing a third-party to define at least one of the behavioral segments; and receiving a third-party definition of at least one behavioral segment.

In some examples, receiving the at least one behavioral segment includes receiving a classification mapping, and wherein the operations further comprise setting behavioral parameters associated with the classification mapping.

In some examples, at least one of the behavioral parameters includes a probability percentage that a page among the plurality of pages viewed by a communications network user relates to the at least one topic of the plurality of topics.

In some examples, at least one of the behavioral parameters includes a probability percentage relating to a frequency with which the page or the at least one topic is seen by the network user.

In some examples, at least one of the behavioral parameters includes a probability percentage relating to a recency with which the page or the at least one topic is seen by the network user.

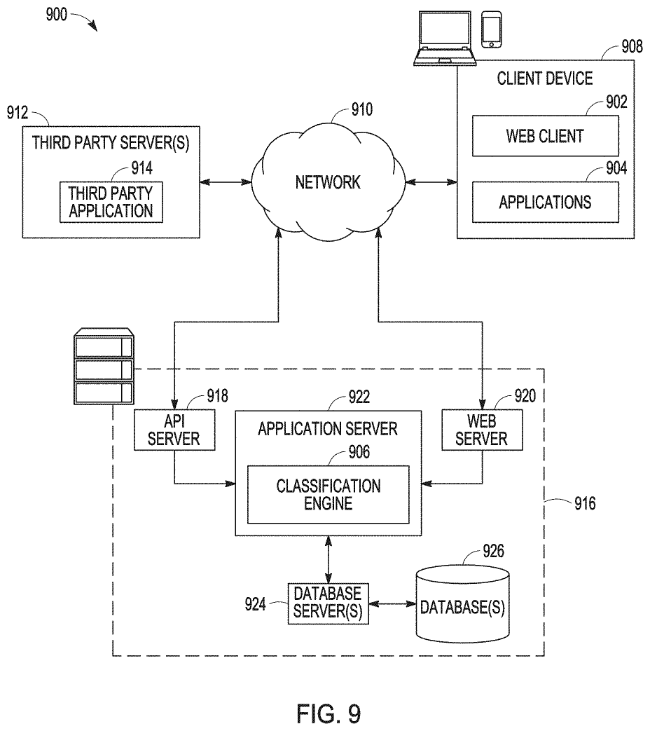

With reference to FIG. 9, an example embodiment of a high-level SaaS network architecture 900 is shown. A networked system 916 provides server-side functionality via a network 910 (e.g., the Internet or a WAN) to a client device 908. A web client 902 and a programmatic client, in the example form of an application 904, are hosted and execute on the client device 908. The networked system 916 includes an application server 922, which in turn hosts a classification engine 906 for performing algorithmic topic clustering of data for real-time prediction and look-alike modeling and other operations described herein. The classification engine 906 provides a number of functions and services to the application 904 that accesses the networked system 916. The application 904 also provides a number of interfaces described herein which facilitate, for example, the presentation of a survey to a user of the client device 908 (e.g., an online consumer seeking actionable content on the network 910), and responses thereto.

The client device 908 enables a user to access and interact with the networked system 916. For instance, the user provides input (e.g., touch screen input or alphanumeric input) to the client device 908, and the input is communicated to the networked system 916 via the network 910. In this instance, the networked system 916, in response to receiving the input from the user, communicates information back to the client device 908 via the network 910 to be presented to the user.

An Application Program Interface (API) server 918 and a web server 920 are coupled, and provide programmatic and web interfaces respectively, to the application server 922. The application server 922 hosts the classification engine 906, which includes components or applications. The application server 922 is, in turn, shown to be coupled to a database server 924 that facilitates access to information storage repositories or inventories (e.g., a database 926). In an example embodiment, the database 926 includes storage devices that store information accessed and generated by the classification engine 906.

Additionally, a third-party application 914, executing on a third-party server(s) 912, is shown as having programmatic access to the networked system 916 via the programmatic interface provided by the API server 918. For example, the third-party application 914, using information retrieved from the networked system 916, may support one or more features or functions on a website hosted by a third party.

Turning now specifically to the applications hosted by the client device 908, the web client 902 may access the various systems (e.g., classification engine 906) via the web interface supported by the web server 920. Similarly, the application 904 (e.g., an “app”) accesses the various services and functions provided by the classification engine 906 via the programmatic interface provided by the API server 918. The application 904 may be, for example, an “app” executing on the client device 908, such as an IOS™ or ANDROID™ OS application to enable a user to access and input data on the networked system 916 in an offline manner, and to perform batch-mode communications between the application 904 and the networked system 916.

Further, while the SaaS network architecture 900 shown in FIG. 9 employs a client-server architecture, the present subject matter is not necessarily limited to such an architecture and could equally-well find application in a distributed, or peer-to-peer, architecture system, for example. The classification engine 906 could also be implemented as a standalone software program, which does not necessarily have networking capabilities.

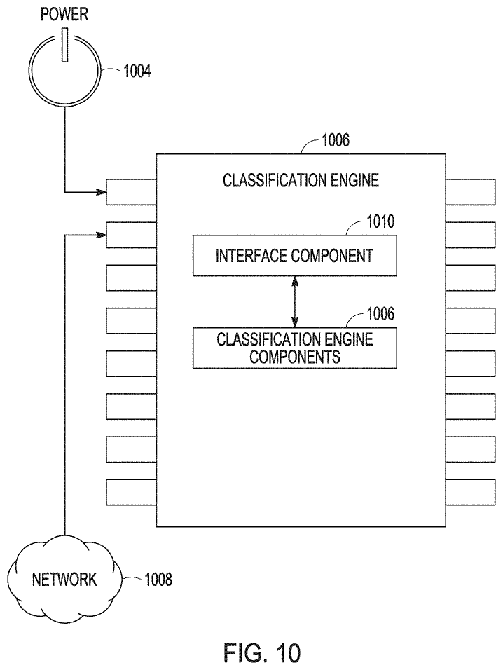

FIG. 10 is a block diagram showing architectural details of a classification engine 906, according to some example embodiments. Specifically, the classification engine 906 is shown to include an interface component 1010 by which the classification engine 906 communicates (e.g., over a network 1008) with other systems within the SaaS network architecture 900.

The interface component 1010 is collectively coupled to one or more classification engine components 1006 that operate to provide specific aspects of algorithmic topic clustering of data for real-time prediction and look-alike modeling, in accordance with the methods described herein with reference to the accompanying drawings.

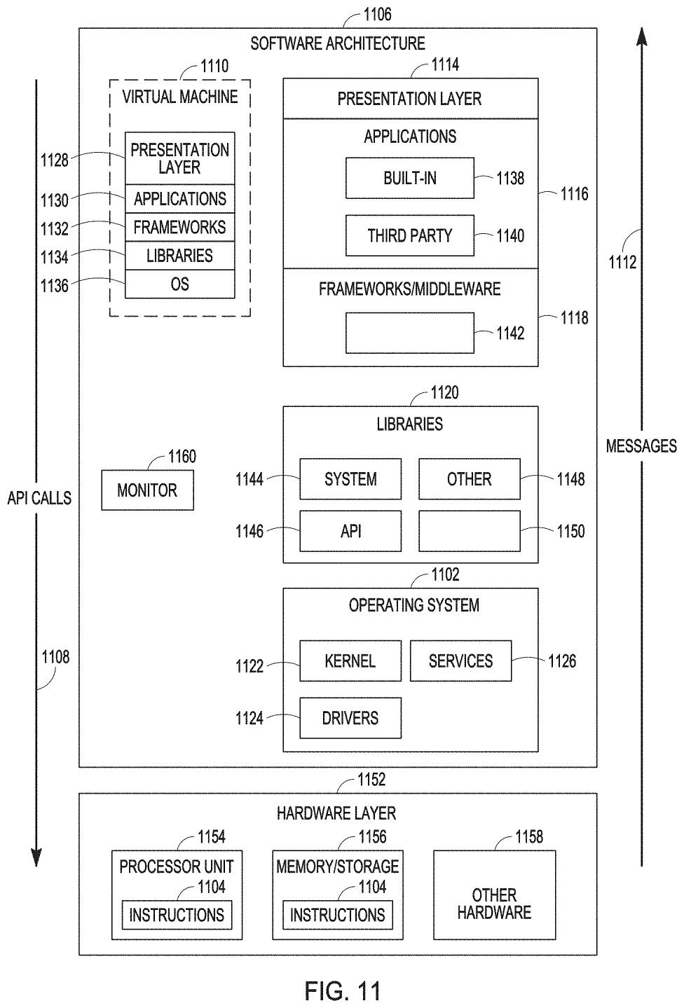

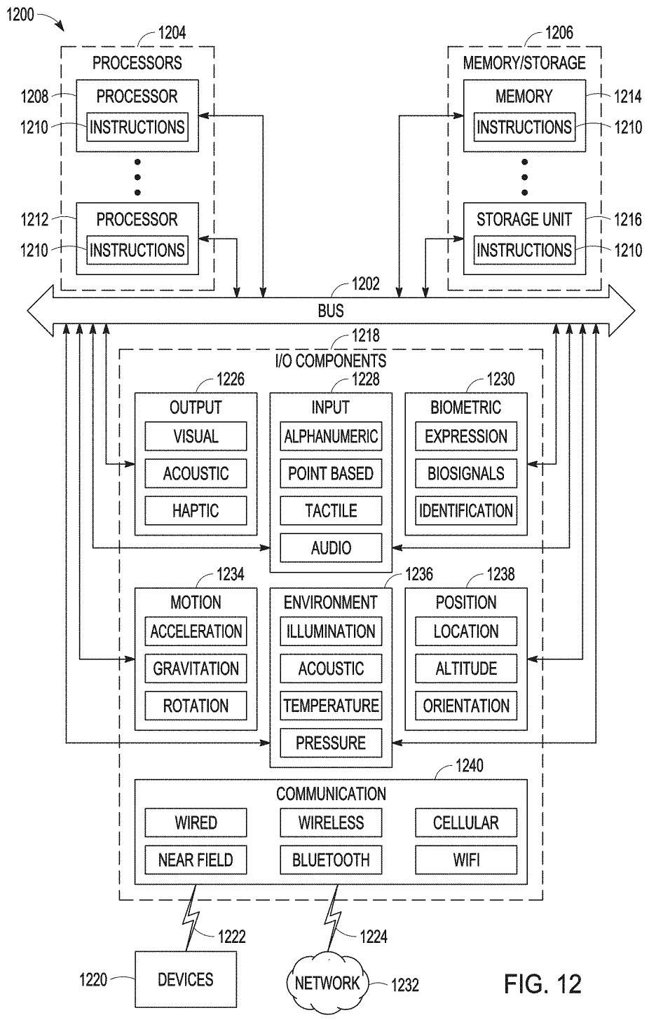

FIG. 11 is a block diagram illustrating an example software architecture 1106, which may be used in conjunction with various hardware architectures herein described. FIG. 11 is a non-limiting example of a software architecture 1106 and it will be appreciated that many other architectures may be implemented to facilitate the functionality described herein. The software architecture 1106 may execute on hardware such as a machine 1200 of FIG. 12 that includes, among other things, processors 1204, memory/storage 1206, and I/O components 1218. A representative hardware layer 1152 is illustrated and can represent, for example, the machine 1200 of FIG. 12. The representative hardware layer 1152 includes a processing unit 1154 having associated executable instructions 1104. The executable instructions 1104 represent the executable instructions of the software architecture 1106, including implementation of the methods, components, and so forth described herein. The hardware layer 1152 also includes memory and/or storage modules as memory/storage 1156, which also have the executable instructions 1104. The hardware layer 1152 may also comprise other hardware 1158.

In the example architecture of FIG. 11, the software architecture 1106 may be conceptualized as a stack of layers where each layer provides particular functionality. For example, the software architecture 1106 may include layers such as an operating system 1102, libraries 1120, frameworks/middleware 1118, applications 1116, and a presentation layer 1114. Operationally, the applications 1116 and/or other components within the layers may invoke application programming interface (API) API calls 1108 through the software stack and receive messages 1112 in response to the API calls 1108. The layers illustrated are representative in nature, and not all software architectures have all layers. For example, some mobile or special-purpose operating systems may not provide a frameworks/middleware 1118, while others may provide such a layer. Other software architectures may include additional or different layers.

The operating system 1102 may manage hardware resources and provide common services. The operating system 1102 may include, for example, a kernel 1122, services 1124, and drivers 1126. The kernel 1122 may act as an abstraction layer between the hardware and the other software layers. For example, the kernel 1122 may be responsible for memory management, processor management (e.g., scheduling), component management, networking, security settings, and so on. The services 1124 may provide other common services for the other software layers. The drivers 1126 are responsible for controlling or interfacing with the underlying hardware. For instance, the drivers 1126 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1120 provide a common infrastructure that is used by the applications 1116 and/or other components and/or layers. The libraries 1120 provide functionality that allows other software components to perform tasks in an easier fashion than by interfacing directly with the underlying operating system 1102 functionality (e.g., kernel 1122, services 1124, and/or drivers 1126). The libraries 1120 may include system libraries 1144 (e.g., C standard library) that may provide functions such as memory allocation functions, string manipulation functions, mathematical functions, and the like. In addition, the libraries 1120 may include API libraries 1146 such as media libraries (e.g., libraries to support presentation and manipulation of various media formats such as MPEG4, H264, MP3, AAC, AMR, IPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1120 may also include a wide variety of other libraries 1148 to provide many other APIs to the applications 1116 and other software components/modules.

The frameworks/middleware 1118 (also sometimes referred to as middleware) provide a higher-level common infrastructure that may be used by the applications 1116 and/or other software components/modules. For example, the frameworks/middleware 1118 may provide various graphic user interface ((QUI) functions, high-level location services, and so forth. The frameworks/middleware 1118 may provide a broad spectrum of other APIs that may be utilized by the applications 1116 and/or other software components/modules, some of which may be specific to a particular operating system or platform.

The applications 1116 include built-in applications 1138 and/or third-party applications 1140. Examples of representative built-in applications 1138 may include, but are not limited to, a contacts application, a browser application, a book reader application, a location application, a media application, a messaging application, and/or a game application. The third-party applications 1140 may include any application developed using the ANDROID™ or IOS™ software development kit (SDK) by an entity other than the vendor of the particular platform and may be mobile software running on a mobile operating system such as IOS™, ANDROID™, WINDOWS™ Phone, or other Mobile operating systems. The third-party applications 1140 may invoke the API calls 1108 provided by the mobile operating system (such as the operating system 1102) to facilitate functionality described herein.

The applications 1116 may use built-in operating system functions (e.g., kernel 1122, services 1124, and/or drivers 1126), libraries 1120, and frameworks/middleware 1118 to create user interfaces to interact with users of the system. Alternatively, or additionally, in some systems, interactions with a user may occur through a presentation layer, such as the presentation layer 1114. In these systems, the application/component “logic” can be separated from the aspects of the application/component that interact with a user.

Some software architectures use virtual machines. In the example of FIG. 11, this is illustrated by a virtual machine 1110. The virtual machine 1110 creates a software environment where applications/components can execute as if they were executing on a hardware machine (such as the machine 1200 of FIG. 12, for example). The virtual machine 1110 is hosted by a host operating system (operating system 1102 in FIG. 11) and typically, although not always, has a virtual machine monitor 1160, which manages the operation of the virtual machine 1110 as well as the interface with the host operating system (i.e., operating system 1102). A software architecture executes within the virtual machine 1110, such as an operating system (OS) 1136, libraries 1134, frameworks 1132, applications 1130, and/or a presentation layer 1128. These layers of software architecture executing within the virtual machine 1110 can be the same as corresponding layers previously described or may be different.

FIG. 12 is a block diagram illustrating components of a machine 1200, according to some example embodiments, able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1210 (e.g., software, a program, an application, an applet, an app, or other executable code) for causing the machine 1200 to perform any one or more of the methodologies discussed herein may be executed. As such, the instructions 1210 may be used to implement modules or components described herein. The instructions 1210 transform the general, non-programmed machine into a particular machine programmed to carry out the specific described and illustrated functions in the manner described.

In alternative embodiments, the machine 1200 operates as a standalone device or may be coupled (e.g., networked) to other machines. To a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a personal computer (PC) a tablet computer, a laptop computer, a netbook, a set-top box (STB), a PDA, an entertainment media system, a cellular telephone, a smart phone, a mobile device, a wearable device (e.g., a smart-watch), a smart home device (e.g., a smart appliance), other smart devices, a web appliance, a network router, a network switch, a network bridge, or any machine capable of executing the instructions 1210, sequentially or otherwise, that specify actions to be taken by the machine 1200. Further, while only a single machine 1200 is illustrated, the term “machine” shall also be taken to include a collection of machines that individually or jointly execute the instructions 1210 to perform any one or more of the methodologies discussed herein.

The machine 1200 may include processors 1204, memory/storage 1206, and I/O components 1218, which may be configured to communicate with each other such as via a bus 1202. The memory/storage 1206 may include a memory 1214, such as a main memory, or other memory storage, and a storage unit 1216, both accessible to the processors 1204 such as via the bus 1202. The storage unit 1216 and memory 1214 store the instructions 1210 embodying any one or more of the methodologies or functions described herein. The instructions 1210 may also reside, completely or partially, within the memory 1214, within the storage unit 1216, within at least one of the processors 1204 (e.g., within the processor's cache memory), or any suitable combination thereof, during execution thereof by the machine 1200. Accordingly, the memory 1214, the storage unit 1216, and the memory of the processors 1204 are examples of machine-readable media.

The I/O components 1218 may include a wide variety of components to receive input, provide output, produce output, transmit information, exchange information, capture measurements, and so on. The specific I/O components 1218 that are included in a particular machine will depend on the type of machine. For example, portable machines such as mobile phones will likely include a touch input device or other such input mechanisms, while a headless server machine will likely not include such a touch input device. It will be appreciated that the I/O components 1218 may include many other components that are not shown in FIG. 12, The I/O components 1218 are grouped according to functionality merely for simplifying the following discussion and the grouping is in no way limiting. In various example embodiments, the I/O components 1218 may include output components 1226 and input components 1228. The output components 1226 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1228 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1218 may include biometric components 1230, motion components 1234, environment components 1236, or position components 1238 among a wide array of other components. For example, the biometric components 1230 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 1234 may include acceleration sensor components (e.g., accelerometer), gravitation sensor components, rotation sensor components (e.g., gyroscope), and so forth. The environment components 1236 may include, for example, illumination sensor components (e.g., photometer), temperature sensor components (e.g., one or more thermometers that detect ambient temperature humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1238 may include location sensor components (e.g., a Global Position System (GPS) receiver component, altitude sensor components (e.g., altimeters or barometers that detect air pressure from which altitude may be derived), orientation sensor components (e.g., magnetometers), and the like.

Communication may be implemented using a wide variety of technologies. The I/O components 1218 may include communication components 1240 operable to couple the machine 1200 to a network 1232 or devices 1220 via a coupling 1224 and a coupling 1222 respectively. For example, the communication components 1240 may include a network interface component or another suitable device to interface with the network 1232. In further examples, the communication components 1240 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1220 may be another machine or any of a wide variety of peripheral devices (e.g., a peripheral device coupled via a USB).

Moreover, the communication components 1240 may detect or include components operable to detect identifiers. For example, the communication components 1240 may include Radio Frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as location via Internet Protocol (IP) geolocation, location via Wi-Fi® signal triangulation, location via detecting an NFC beacon signal that may indicate a particular location, and so forth.

In this example, the systems and methods are described in the general context of computer program instructions executed by one or more computing devices that can take the form of a traditional server/desktop/laptop, mobile device such as a smartphone or tablet, etc. Computing devices typically include one or more processors coupled to data storage for computer program modules and data. Key technologies include, but are not limited to, the multi-industry standards of Microsoft and Linux/Unix based Operating Systems, databases such as SQL Server, Oracle, NOSQL, and DB2, Business Analytic/Intelligence tools such as SPSS, Cognos, SAS, etc., development tools such as Java, NET Framework (VB.NET, ASP.NET, AJAX.NET, etc.), and other e-commerce products, computer languages, and development tools. Such program modules generally include computer program instructions such as routines, programs, objects, components, etc., for execution by the one or more processors to perform particular tasks, utilize data, data structures, and/or implement particular abstract data types. While the systems, methods, and apparatus are described in the foregoing context, acts and operations described hereinafter may also be implemented in hardware.

Although the subject matter has been described with reference to specific example embodiments, it will be evident that various modifications and changes may be made to these embodiments without departing from the broader spirit and scope of the disclosed subject matter. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Description, therefore, is not to be taken in a limiting sense, and the scope of various embodiments is defined only by any appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A user classification system comprising:
a communications network;
a Front-End URL Handler (FEUH) establishing an entry point for content calls from a network user;
a Fast Retrieval (FR) store storing a set of behavioral segments; and
a classification engine comprising one or more processors and a memory storing instructions which, when executed by at least one processor in the one or more processors, cause the at least one processor to perform operations comprising:
accessing a plurality of pages viewed by a communications network user;
classifying the plurality of pages as pertaining to at least one topic of a plurality of topics;
tracking a count of each of the plurality of pages viewed by the communications network user for each of the topics;
tracking a recency or frequency with which each of the plurality of pages viewed by the communications network user was viewed for each of the topics;
characterizing the communications network user as belonging to one or more of the behavioral segments based on the tracked count and tracked recency; and
serving content to the communications network user based on a targeting parameter and the behavioral segment characterization.

2. The user classification system of claim 1, wherein the operations further comprise:
providing a third-party user interface allowing a third-party to define at least one of the behavioral segments; and
receiving a third-party definition of at least one behavioral segment.

3. The user classification system of claim 2, wherein receiving the at least one behavioral segment includes receiving a classification mapping, and wherein the operations further comprise setting behavioral parameters associated with the classification mapping.

4. The user classification system of claim 3, wherein at least one of the behavioral parameters includes a probability percentage that a page among the plurality of pages viewed by a communications network user relates to the at least one topic of the plurality of topics.

5. The user classification system of claim 4, wherein at least one of the behavioral parameters includes a probability percentage relating to a frequency with which the page or the at least one topic is seen by the network user.

6. The user classification system of claim 4, wherein at least one of the behavioral parameters includes a probability percentage relating to a recency with which the page or the at least one topic is seen by the network user.

7. A method, at a classification system, of classifying a communications network user, the method comprising:
accessing a plurality of pages viewed by the communications network user;
classifying the plurality of pages as pertaining to at least one topic of a plurality of topics;
tracking a count of each of the pages viewed by the communications network user for each of the topics;
tracking a recency or frequency with which each of the pages viewed by the communications network user was viewed for each of the topics;
characterizing the communications network user as belonging to one or more behavioral segments based on the tracked count and tracked recency; and
serving content to the communications network user based on a targeting parameter and the behavioral segment characterization.

8. The method of claim 7, further comprising:
providing a third-party user interface allowing a third-party to define at least one of the behavioral segments; and
receiving a third-party definition of at least one behavioral segment.

9. The method of claim 8, wherein receiving the at least one behavioral segment includes receiving a classification mapping, and wherein the method further comprising setting behavioral parameters associated with the classification mapping.

10. The method of claim 9, wherein at least one of the behavioral parameters includes a probability percentage that a page among the plurality of pages viewed by a communications network user relates to the at least one topic of the plurality of topics.

11. The method of claim 10, wherein at least one of the behavioral parameters includes a probability percentage relating to a frequency with which the page or the at least one topic is seen by the network user.

12. The method of claim 10, wherein at least one of the behavioral parameters includes a probability percentage relating to a recency with which the page or the at least one topic is seen by the network user.

13. A non-transitory machine-readable medium including instructions which, when read by a machine, cause the machine to perform operations in a method of classifying a communications network user, the operations comprising:
accessing a plurality of pages viewed by the communications network user;
classifying the plurality of pages as pertaining to at least one topic of a plurality of topics;
tracking a count of each of the pages viewed by the communications network user for each of the topics;
tracking a recency or frequency with which each of the pages viewed by the communications network user was viewed for each of the topics;
characterizing the communications network user as belonging to one or more behavioral segments based on the tracked count and tracked recency; and
serving content to the communications network user based on a targeting parameter and the behavioral segment characterization.

14. The medium of claim 13, wherein the operations further comprise:
providing a third-party user interface allowing a third-party to define at least one of the behavioral segments; and
receiving a third-party definition of at least one behavioral segment.

15. The medium of claim 14, wherein receiving the at least one behavioral segment includes receiving a classification mapping, and wherein the operations further comprise setting behavioral parameters associated with the classification mapping.

16. The medium of claim 15, wherein at least one of the behavioral parameters includes a probability percentage that a page among the plurality of pages viewed by a communications network user relates to the at least one topic of the plurality of topics.

17. The medium of claim 15, wherein at least one of the behavioral parameters includes a probability percentage relating to a frequency with which the page or the at least one topic is seen by the network user.

18. The medium of claim 15, wherein at least one of the behavioral parameters includes a probability percentage relating to a recency with which the page or the at least one topic is seen by the network user.
